(19) United States
(12) Patent Application Publication
(10) Pub. No.: US 2020/0047787 A1
(43) Pub. Date: Feb. 13, 2020

(54) DIVIDER SYSTEM FOR A SHOPPING CART

(71) Applicant: Walmart Apollo, LLC, Bentonville, AR (US)

(72) Inventors: Yurgis Mauro Bacallao, Centerton, AR (US); Bruce Green, Centerton, AR (US)

(21) Appl. No.: 16/516,626

(22) Filed: Jul. 19, 2019

Related U.S. Application Data
(60) Provisional application No. 62/717,301, filed on Aug. 10, 2018.

(51) Int. Cl. B62B 5/00; B62B 3/14; B62B 3/00

(52) U.S. Cl. CPC B62B 5/00; B62B 3/002; B62B 3/14

(57) ABSTRACT

Described is a divider system that divides a shopping cart basket up into compartments so that items in the shopping basket can be kept separate from each other. The divider system includes a first divider and a second divider that couple to one another using a slot in the second divider. The first divider and the second divider are each flat elongate panel assemblies of multiple flat panel structures. The first and second dividers are formed of three flat panels, two outer hollow panels and a center panel that slides into and out of each of the two hollow outer panels. With the divider system inserted into the basket of a shopping cart and coupled to the shopping cart, the divider system divides the shopping basket into multiple compartments for dividing items in the shopping basket.

### CROSS REFERENCE TO RELATED APPLICATION

This invention claims priority to U.S. provisional patent application Ser. No. 62/717,301, filed Aug. 10, 2018, and entitled “Divider System for a Shopping Cart”, which is incorporated entirely herein by reference.

### BACKGROUND OF THE INVENTION

### Technical Field

This invention relates to accessories for retail store shopping carts and specifically to a divider panel system that divides a shopping basket of a shopping cart up into multiple compartments.

### State of the Art

Shopping carts are used by shoppers to collect items to be purchased while shopping in a retail store. Shopping carts often have one large main shopping basket and a fold-out smaller basket and/or child seat. The large main shopping basket is used to put items in while shopping. However, it desirable to have a way to divide up the large main shopping basket into multiple compartments. A shopping basket divider would give the customer a way to keep different types of items separate in their shopping basket. For employees using a shopping basket to return or collect items, a divider would give the employee a way to keep different types of items separate, or separate items for different customers.

Accordingly, what is needed is a divider that fits in the shopping basket of a shopping cart and divides the shopping basket up into multiple separate compartments.

### BRIEF DESCRIPTION OF THE DRAWINGS

FIG. 1 shows a top perspective view of a divider system for a shopping cart coupled to a shopping cart;

FIG. 2 shows a bottom perspective view of the divider system for a shopping cart of FIG. 1 coupled to a shopping cart;

FIG. 3 shows a top perspective view of a divider system for a shopping cart;

FIG. 4 illustrates a bottom perspective view of a first divider first end panel;

FIG. 5 illustrates a top perspective view of the first divider first end panel of FIG. 4;

FIG. 6 shows a side view of the first divider first end panel of FIG. 4;

FIG. 7 shows a front view of a first divider center panel;

FIG. 8 illustrates a side view of the first divider center panel of FIG. 7;

FIG. 9 illustrates a front perspective view of a second divider first end panel; and

FIG. 10 shows a front view of a second divider center panel.

### DETAILED DESCRIPTION OF EMBODIMENTS OF THE INVENTION

As discussed above, embodiments of the invention relate to accessories for retail store shopping carts, and specifically to a divider panel that divides a shopping basket of a shopping cart up into multiple compartments. Disclosed is a divider system for a shopping cart that includes a first divider and a second divider. The first divider and the second divider are each flat panels formed of multiple sections that side into and out of each other to adjust the length of each divider. The second divider has a slot. The slot allows the second divider to slide over the first divider, with the first divider sliding into the slot. With the first and the second divider coupled together, the divider system fits inside the shopping basket of a shopping cart to divide the shopping basket up into four compartments. Either the first divider or the second divider can be used alone if it is desired to divide the shopping basket up into two compartments. The second divider slides towards the front or the back of the shopping cart on the top of the first divider to adjust the size of the compartments. The divider system divides the shopping basket up into multiple adjustable-sized compartments. The multiple compartments can be used to divide up the items in the shopping cart. Customers often want to keep cleaning supplies separate from food, for example, or freezer items away from hot food. The shopping cart divider system provide the customer a means to divide the shopping cart basket into multiple compartments and organize the items to be purchased. An employee using the shopping cart with divider system can keep items for different customers separate, for example, or divide up items in the cart being used for different tasks. The shopping cart divider system has couplers that allow the shopping cart divider system to be easily and removably coupled to the shopping basket.

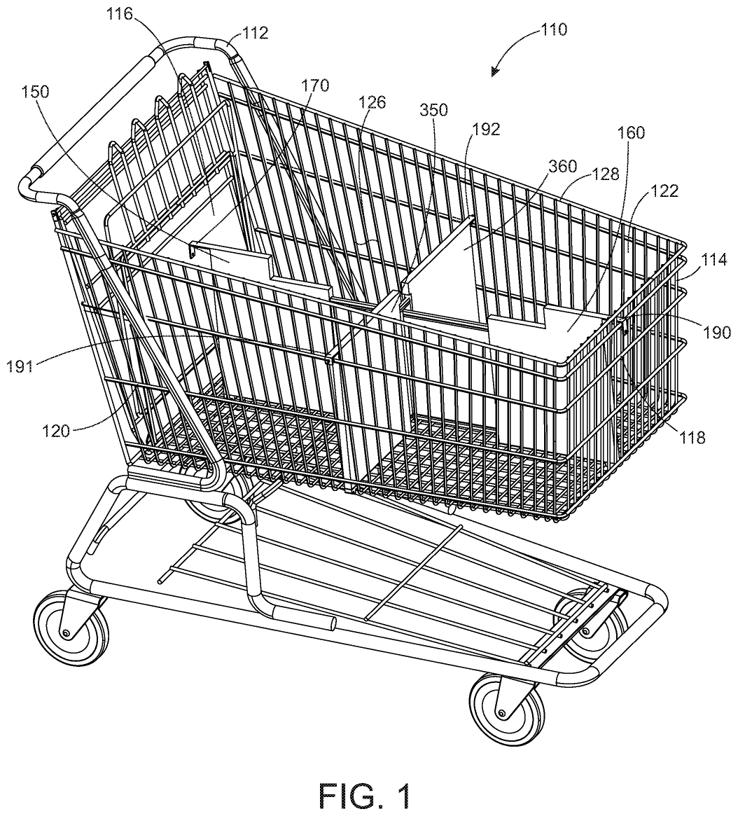

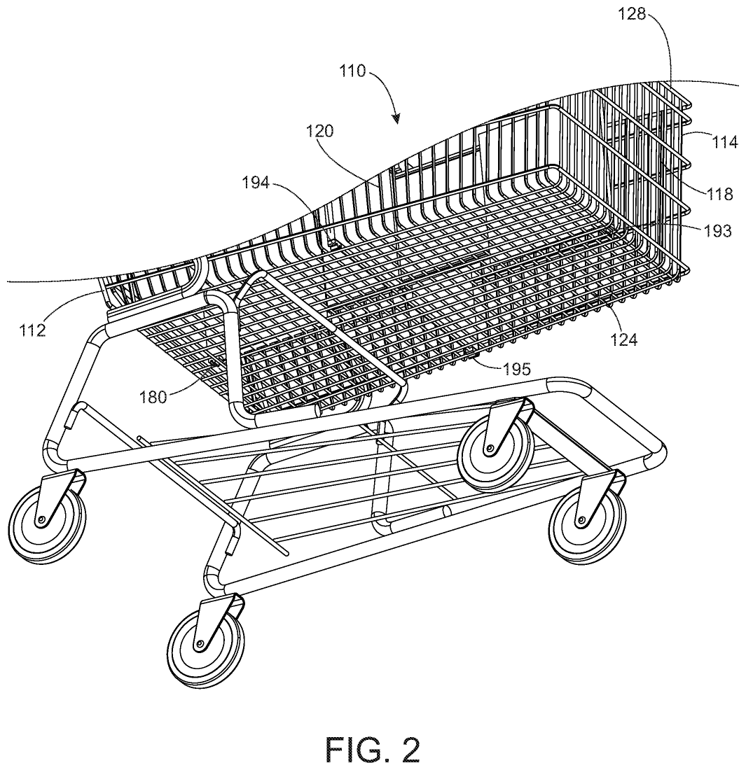

FIG. 1 and FIG. 2 show a divider system 110 coupled to a shopping cart 112. FIG. 1 shows a top perspective view of the combination of shopping cart 112 and divider system 110. FIG. 2 shows a bottom perspective view of shopping cart 112 and divider system 110. Shopping cart 112, in this embodiment, has a shopping cart basket 114, as well as a handle coupled to shopping cart basket 114 and wheels for shopping cart 112 to roll around on coupled to shopping cart basket 114. Divider system 110 is inside shopping cart basket 114 and coupled to shopping cart basket 114 to divide shopping cart basket 114 into multiple compartments.

Shopping cart basket 114 includes a shopping basket bottom 124 (see FIG. 2) formed of a lattice of wire rods. Shopping cart basket 114 is formed completely of a lattice of wire rods in this embodiment, but this is not meant to be limiting. The lattice of wire rods that forms shopping basket bottom 124 forms a grid of rectangular holes in shopping basket bottom 124. These rectangular holes through basket bottom 124 are used, in some embodiments, by divider system 110 to couple divider system 110 to shopping cart basket 114. Divider system 110 has four bottom plug couplers 180, 193, 194, and 195 as shown in FIG. 2, which are used to couple divider system 110 to shopping cart basket bottom 124 of shopping cart basket 114. Any one or more of bottom plug couplers 180, 193, 194, or 195 can be used to couple divider system 110 to shopping cart basket 114.

Shopping cart basket 114 also has four shopping cart basket sides, a first side 116, a second side 118, a third side 120, and a fourth side 122, as shown in FIG. 1 and FIG. 2. Each shopping cart basket side 116, 118, 120, and 122 are coupled to shopping cart basket bottom 124. Shopping cart basket 114 has a shopping cart basket open top 126 so that items can be placed in shopping cart basket 114. A top rail 128 encircles shopping cart basket open top 126. Top rail 128 is the top rail of sides 116, 118, 120, and 122, coupled to sides 116, 118, 120, and 122, and defines the perimeter of shopping cart basket open top 126. Divider system 110 has four bar clips 170, 190, 191, and 192 that couple divider system 110 to a rail of shopping cart basket 114 as shown in FIG. 1 and explained in this document. Bar clips 170, 190, 191, and 192 can couple divider system 110 to top rail 128 or any other rail of shopping cart basket 114. Any one or more of bar clips 170, 190, 191, or 192 can be used to couple divider system 110 to a rail of shopping cart basket 114.

With divider system 110 coupled to shopping cart basket 114 of shopping cart 112 using bottom plug couplers 180, 193, 194, and 195 and bar clips 170, 190, 191, and 192, divider system 110 divides shopping basket 114 into multiple compartments. A customer or an employee using shopping cart 112 can use the compartments to hold items, with divider system 110 keeping the items apart from each other.

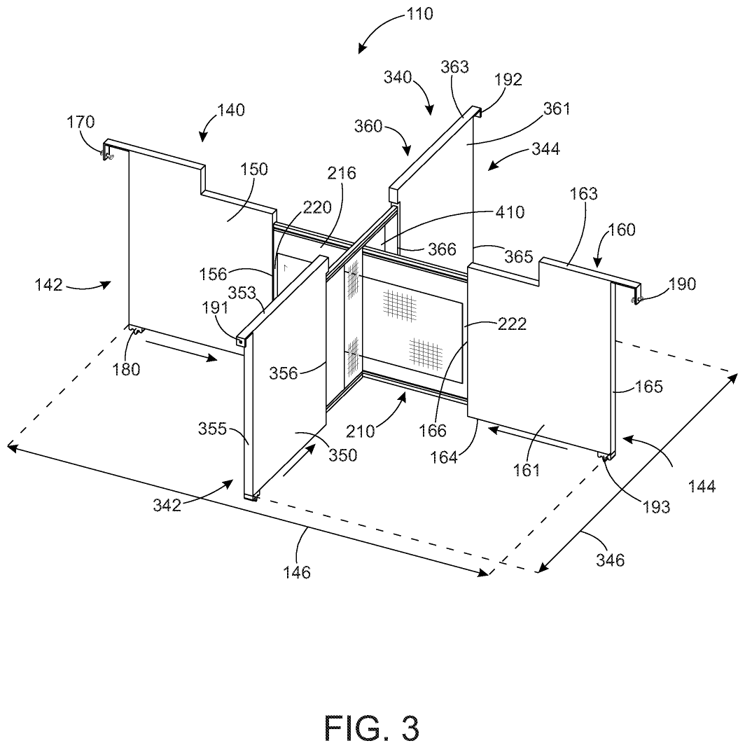

FIG. 3 shows a top perspective view of divider system 110 removed from shopping cart 112. Divider system 110 includes a first divider 140 and a second divider 340. First divider 140 and second divider 340 are each flat panels formed of multiple panel sections that slidingly couple to each other so that each one of first divider 140 and second divider 340 have adjustable lengths. Second divider 340 removably couples to first divider 140 so that first divider 140 and second divider 340 form a cross or an X in top view, see FIG. 1 and FIG. 3. Second divider 340 slidingly sets on first divider 140, see FIG. 3. Second divider 340 sliding along first divider 140 adjusts the size of the compartments in shopping cart basket 114.

First divider 140 has a first divider first end 142 and a first divider second end 144 opposing first divider first end 142, see FIG. 3. First divider 140 has an adjustable first divider length 146. First divider 140 is formed of a first divider first end panel 150, a first divider second end panel 160, and a first divider center panel 210, see FIG. 3. First divider first end panel 150 is at first divider first end 142. First divider second end panel 160 is at first divider second end 144. First divider center panel 210 is between first divider first end panel 150 and first divider second end panel 160. First divider first end panel 150 and first divider second end panel 160 are each hollow panels. First divider center panel 210 is not hollow. First divider center panel 210 is sized and shaped to slide into and out of each one of first divider first end panel 150 and first divider second end panel 160. First divider center panel 210 sliding into and out of first divider first end panel 150 and first divider second end panel 160 adjust first divider length 146, as shown in FIG. 3.

Second divider 340 has an adjustable second divider length 346. Second divider 340 is formed of a second divider first end panel 350, a second divider second end panel 360, and a second divider center panel 410, see FIG. 3. Second divider first end panel 350 and second divider second end panel 360 are each hollow panels. Second divider center panel 410 is not hollow. Second divider center panel 410 is sized and shaped to slide into and out of each one of second divider first end panel 350 and second divider second end panel 360. Second divider center panel 410 sliding into and out of second divider first end panel 350 and second divider second end panel 360 adjust second divider length 346, as shown in FIG. 3.

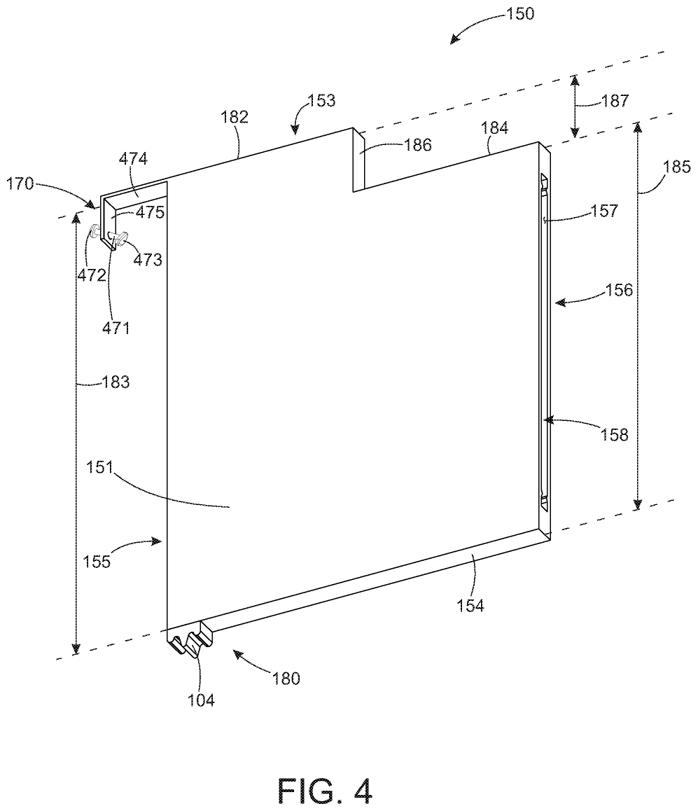

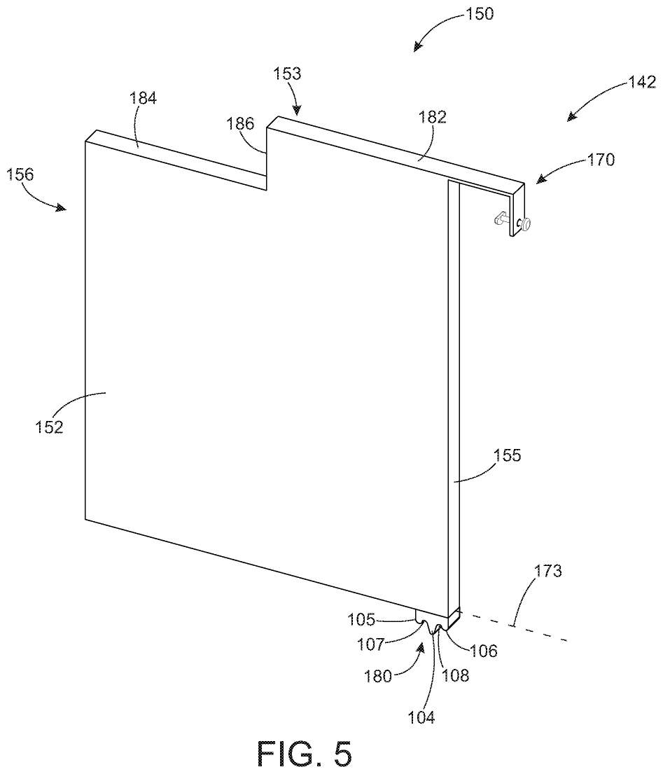

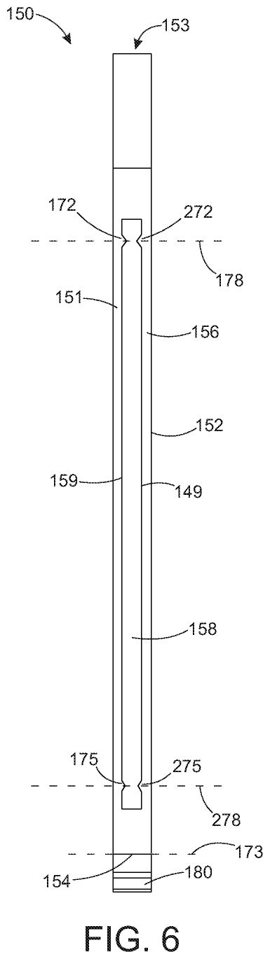

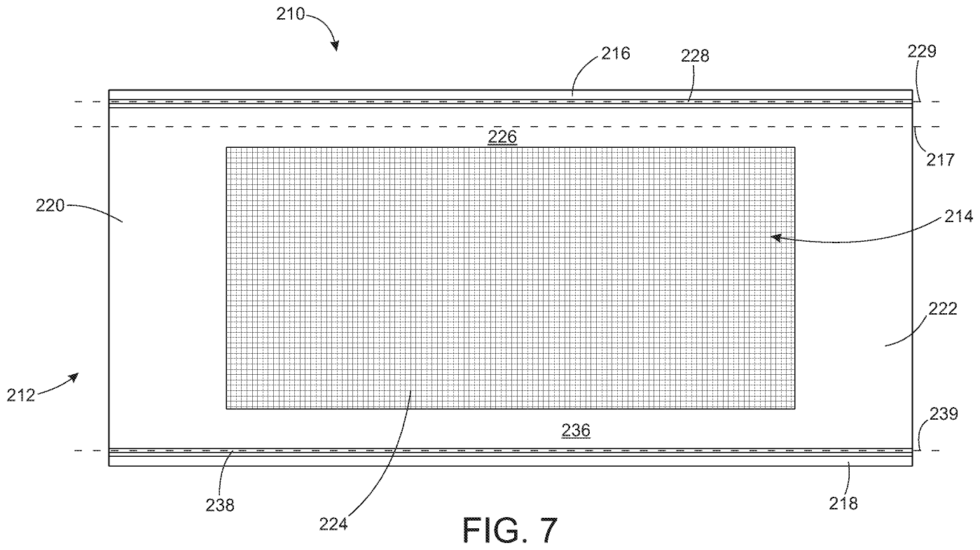

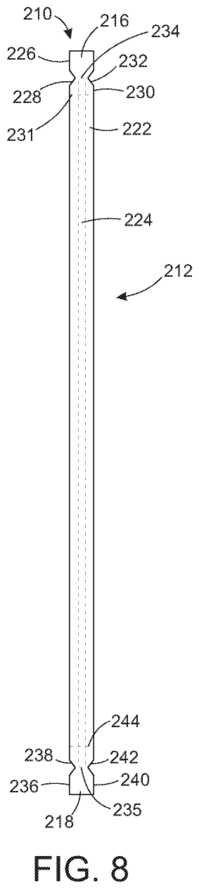

FIG. 4 through FIG. 8 show details of first divider 140. FIG. 4 shows a bottom front perspective view of first divider first end panel 150. FIG. 5 shows a top rear perspective view of first divider first end panel 150. FIG. 6 shows a side view of first divider first end panel 150, looking at first divider first end panel inner side 156 of first divider first end panel 150. FIG. 7 shows a front view of first divider center panel 210. FIG. 8 shows a side view of first divider center panel 210.

First divider first end panel 150, as shown in FIG. 3 through FIG. 6, is a hollow panel having a first divider first end front plate 151, and a first divider first end rear plate 152, see FIG. 4, FIG. 5, and FIG. 6. First divider first end rear plate 152 is spacedly coupled to first divider first end front plate 151. First divider first end front plate 151 and first divider first end rear plate 152 are each flat plates of rigid material which have a six-sided polygon shape in front view. A first divider first end cavity 157 (FIG. 4) is between first divider first end front plate 151 and first divider first end rear plate 152.

First divider first end front plate 151 and first divider first end rear plate 152 are held spaced from one another by a first divider first end panel top side 153, a first divider first end panel bottom side 154, a first divider first end panel outer side 155 at first divider first end 142, and a first divider first end panel inner side 156 opposing first divider first end panel outer side 155.

First divider first end panel inner side 156 is a rectangular panel with a first divider first end panel opening 158 through it to allow first divider center panel 210 to slide into and out of first divider first end panel inner side 156. First divider first end panel inner side 156 has a first divider first end panel height 185, see FIG. 4. First divider first end panel inner side 156 has first divider first end panel opening 158 through first divider first end panel inner side 156, see FIG. 4 and FIG. 6. First divider first end panel opening 158 is through first divider first end panel inner side 156 to allow access to first divider first end cavity 157. First divider center panel 210 slides into and out of first divider first end cavity 157 of first divider first end panel 150 through first divider first end panel opening 158.

First divider first end panel outer side 155 is a rectangular panel of rigid material that forms an outer side to first divider first end panel 150. First divider first end panel outer side 155 has a first divider first end panel outer side height 183, see FIG. 4. First divider first end panel bottom side 154 is a rectangular panel of rigid material that forms a bottom side to first divider first end panel 150.

First divider first end panel top side 153 is formed of three rectangular sections, first section 182, second section 186, and third section 184, see FIG. 4 and FIG. 5. First divider first end panel top side 153 is divided into three sections 182, 186, and 184 so that first divider first end panel top side 153 is “stepped”. First divider first end panel top side 153 is stepped so that second divider 340 can be coupled to first divider 140, with second divider 340 having the same height as first divider 140 when second divider 340 is setting on top of first divider 140, as explained herein. First section 182 is coupled to and perpendicular to first divider first end panel outer side 155. First section 182 is parallel to first divider first end panel bottom side 154 and is spaced apart from first divider first end panel bottom side 154 by first divider first end panel outer side height 183. Third section 184 is coupled to and perpendicular to first divider first end panel inner side 156. Third section 184 is parallel to first divider first end panel bottom side 154 and is spaced apart from first divider first end panel bottom side 154 by first divider first end panel inner side height 185. Second section 186 extends between first section 182 and third section 184, and is coupled to both first section 182 and third section 184. Third section 186 is parallel to both first divider first end panel inner side 156 and first divider first end panel outer side 155. Third section 186 has a third section height 187, see FIG. 4. First divider first end panel outer side height 183 is equal to first divider first end panel inner side height 185 plus third section height 187.

First divider first end front plate 151 and first divider first end rear plate 152 are spaced apart from one another, with first divider first end cavity 157 in between. First divider center panel 210 slides into and out of first divider first end cavity 157. First divider first end front plate 151 and first divider first end rear plate 152 have ridges on their inner surface that mate with grooves on an outer surface of first divider center panel 210 to guide first divider center panel 210 into and out of first divider first end cavity 157.

First divider first end front plate 151 has a first end front plate inner surface 159, see FIG. 6. First divider first end front plate 151 has two ridges, a front top ridge 172 and a front bottom ridge 175 extending or protruding from first end front plate inner surface 159. Front top ridge 172 and front bottom ridge 175 are each triangular shaped protrusions with straight longitudinal axes. Front top ridge 172 and front bottom ridge 175 each protrude from first end front plate inner surface 159 into first divider first end cavity 157. Front top ridge 172 and front bottom ridge 175 and their respective longitudinal axes each extend along first end front plate inner surface 159 from first divider first end panel inner side 156 to first divider first end panel outer side 155. Front top ridge 172 and front bottom ridge 175 have longitudinal axes that are parallel to a first divider first end panel bottom side plane 173, see FIG. 5 and FIG. 6. Front top ridge 172 is positioned closer to first divider first end panel top side 153 than first divider first end panel bottom side 154. Front bottom ridge 175 is positioned closer to first divider first end panel bottom side 154 than first divider first end panel top side 153.

First divider first end rear plate 152 has a first end rear plate inner surface 149, see FIG. 6. First divider first end rear plate 152 has two ridges, a rear top ridge 272 and a rear bottom ridge 275 extending or protruding from first end rear plate inner surface 149. Rear top ridge 272 and rear bottom ridge 275 are each triangular shaped protrusions with straight longitudinal axes. Rear top ridge 272 and rear bottom ridge 275 and their respective longitudinal axes each extend along first end rear plate inner surface 149 from first divider first end panel inner side 156 to first divider first end panel outer side 155. Rear top ridge 272 and rear bottom ridge 275 have longitudinal axes that are parallel to first divider first end panel bottom side plane 173. Rear top ridge 272 is positioned closer to first divider first end panel top side 153 than first divider first end panel bottom side 154. Rear bottom ridge 275 is positioned closer to first divider first end panel bottom side 154 than first divider first end panel top side 153.

Front top ridge 172 and rear top ridge 272 are parallel to each other, and define a top ridge plane 178, see FIG. 6. Top ridge plane 178 is parallel to first divider first end panel bottom side plane 173, see FIG. 6. Front bottom ridge 175 and rear bottom ridge 275 are parallel to each other and define a bottom ridge plane 278. Bottom ridge plane 278 is parallel to first divider first end panel bottom side plane 273.

First divider first end panel 150 also includes a first bar clip 170, see FIG. 1, FIG. 3, and FIG. 4. First bar clip 170 is used to couple first divider 140, specifically first divider first end panel 150, to a rail of shopping cart basket 114. In some embodiments, first bar clip is coupled to top rail 128, but this is not meant to be limiting. First bar clip 170 can be coupled to any bar or rail of shopping cart basket 114. First bar clip 170 is coupled to first divider first end panel outer side 155 at first divider first end 142. First bar clip 170 couples to a bar or rail of shopping cart basket 114 to couple first divider 140, specifically first divider first end panel 150, to shopping cart 112. First bar clip 170 is a rocker coupler having a rocker arm 471 with a rocker handle 472 at one end and a rocker head 473 at the other end of rocker arm 471, see FIG. 4. Rocker arm 471 is an elongate rod or bar. Rocker arm 471 is tiltingly coupled to a side plate 475 such that rocker arm 471 extends through side plate 475, with rocker head 473 on one side of side plate 475 and rocker handle 472 on the other side of side plate 475. Rocker handle 472 move up and down, which tilts rocker arm 472 and moves rocker head 473 up and down. Rocker handle 472 is an elongate bar coupled to rocker arm 471 such that rocker arm 471 and rocker handle 473 are T-shaped. Rocker head 474 is semicircular shaped with the rounded outer surface pointing away from rocker handle 472. First bar clip 170 is formed of an elastic material such as rubber, in this embodiment, but can be formed of many different materials including rigid materials like wood, metal, or plastic.

A top plate 474, a flat rectangular plate of rigid material, is coupled to first divider first end panel outer side 155 at the junction of first divider first end panel outer side 155 and first divider first end panel top side 153. Top plate 174 extends from and lies in the same plane as first section 182. First divider first end panel 150 is coupled to shopping cart basket 114 by first setting top plate 474 on top rail 128 or another rail or bar of shopping basket 114. Side plate 475, a flat rectangular plate of rigid material, extends from top plate 474 such that side plate 475 is perpendicular to top plate 474 and parallel to first divider first end panel outer side 155. Side plate 475 holds first bar clip 170 a spaced distance from first divider first end panel outer side 155. Rocker arm 472 tiltingly extends through side plate 475 with rocker head 472 extending away from first divider first end panel outer side 155, and rocker head 473 extending towards first divider first end panel outer side 155, see FIG. 4 and FIG. 5. When top plate 474 is hung on top rail 128 or another rail or bar of shopping basket 114, rocker head 473 can be made to engage or disengage with top rail 128 or another rail or bar of shopping basket 114 to couple or uncouple first bar clip 170 and first divider first end panel 150 to shopping basket 114. Rocker head 473 can be made to engage or disengage with a rail or bar of shopping basket 114 by moving rocker handle 472 up or down, which tilts rocker arm 471 and moves rocker head 473 up or down against the rail or bar of shopping basket 114. Rocker head 473 has an outer semicircular shape and engages a rail or bar of shopping basket 114 when rocker head 473 is moved up towards top plate 474. Rocker head 473 disengages from the rail or bar of shopping basket 114 by moving rocker head 473 down away from top plate 474.

First bar clip 170 is one of two bar clips used to couple and uncouple first divider 140 to shopping cart basket 114. Second bar clip 190 is coupled to first divider second end panel 160 at first divider second end 144, and similarly couples and uncouples first divider second end panel 160 from top rail 128 or any other rail or bar of shopping basket 114.

First divider first end panel 150 also has a first bottom plug coupler 180 to couple first divider 140, and specifically first divider first end panel 150, to shopping cart basket 114. First bottom plug coupler 180 is a block of elastic material, rubber, in this embodiment. First bottom plug coupler 180 has five flat sides and one wavy side. The wavy side includes three rounded triangular shaped peaks, center peak 104, first side peak 105, and second side peak 106, and two rounded triangular shaped valleys in between the peaks, first valley 107 and second valley 108, see FIG. 5. Center peak 104 is taller than first and second side peaks 105 and 106 in this embodiment. First bottom plug coupler 180 is coupled to first divider first end panel bottom side 154, see FIG. 4, FIG. 5, and FIG. 6. First bottom plug coupler 180 is sized to friction fit with a first opening in shopping cart basket bottom. First bottom plug coupler 180 is sized so that center peak 104 friction fits through the first opening in shopping cart basket bottom 124, with first valley 107 and second valley 108 sitting on two rails of shopping cart basket bottom 124. But this is not meant to be limiting. Many different portions of first bottom plug coupler 180 can be friction fit into shopping cart basket bottom 124. A friction fit means once center peak 104, or another portion of first bottom plug coupler 180, is pushed into the first opening, it is held there by friction with the rails surrounding first opening. Shopping cart basket bottom 124 is formed of a lattice of wires, rods, or rails, which forms a grid of openings through shopping cart basket bottom 124. A portion of first bottom plug coupler 180 such as center peak 104 of first bottom plug coupler 180 is extended through the first opening. As center peak 104 extends deeper through the first opening, center peak gets wide at its bottom and friction couples or fits to the rails surrounding the first opening until center peak 104 is friction fit into the first opening and first valley 107 and second valley 108 sit on two rails surrounding the first opening. First bottom plug coupler 180 is coupled to first divider first end panel bottom side 154 with center peak 104 (on the wavy side) away from first divider first end panel bottom side 154, see FIG. 4 and FIG. 5. The wavy side with center peak 104, first and second side peak 105 and 106, and valleys 107 and 108 provides first bottom plug coupler 180 the give needed to slip first bottom plug coupler 180 into the first opening to friction couple first divider 140, specifically first divider first end panel 150, to shopping cart basket bottom 124, see FIG. 2.

First bottom plug coupler 180 is one of two bottom plug couplers used to couple and uncouple first divider 140 to shopping cart basket 114. Bottom plug coupler 193 is coupled to first divider second end panel 160 and similarly couples and uncouples first divider second end panel 160 to shopping cart basket bottom 124, see FIG. 2.

First divider second end panel 160 is a mirror image of first divider first end panel 150, as best seen in FIG. 3. First divider second end panel 160 is a hollow panel having a first divider second end front plate 161, and a first divider second end rear plate, not shown. The first divider second end rear plate is spacedly coupled to first divider second end front plate 161. First divider second end front plate 161 and the first divider second end rear plate are each flat plates of rigid material which have a six-sided polygon shape in front view. A first divider second end cavity is between first divider second end front plate 161 and the first divider second end rear plate.

First divider second end front plate 161 and the first divider second end rear plate are held spaced from one another by a first divider second end panel top side 163, a first divider second end panel bottom side 164, a first divider second end panel outer side 165 at first divider second end 144, and a first divider second end panel inner side 166 opposing first divider second end panel outer side 165.

First divider second end panel inner side 166 is a rectangular panel with an opening through it to allow first divider center panel 210 to slide into and out of first divider second end panel inner side 166. First divider second end panel inner side 166 mirrors first divider first end panel inner side 156. First divider second end panel inner side 166 has a first divider second end panel opening (not seen in figures) through first divider second end panel inner side 166. The first divider second end panel opening is through first divider second end panel inner side 166 to allow access to the first divider second end panel cavity. First divider center panel 210 slides into and out of the first divider second end cavity of first divider second end panel 160 through the first divider second end panel opening.

First divider second end panel outer side 165 is a rectangular panel of rigid material that forms an outer side to first divider second end panel 160. First divider second end panel outer side 165 has a first divider second end panel outer side height that is equal to first divider first end panel outer side height 183. First divider second end panel bottom side 164 is a rectangular panel of rigid material that forms a bottom side to first divider second end panel 160.

First divider second end panel top side 163 is formed of three rectangular sections, mirroring first divider first end panel top side 153, see FIG. 3. First divider second end panel inner side 166 has a first divider second end panel inner side height equal to first divider first end panel inner side height 185.

First divider second end front plate 161 and the first divider second end rear plate are spaced apart from one another, with the first divider second end cavity in between. First divider center panel 210 slides into and out of the first divider second end cavity, see FIG. 3. First divider second end front plate 161 and the first divider second end rear plate have ridges on their inner surface that mirror the ridges on first divider first end front plate 151 and first divider first end rear plate 152. The ridges mate with grooves on an outer surface of first divider center panel 210 to guide first divider center panel 210 into and out of the first divider second end cavity, just as explained for first divider first end panel 150.

First divider second end panel 160 includes a second bar clip 190. Second bar clip 190 is used to couple first divider 140, specifically first divider second end panel 160, to top rail 128 or any other rail or bar of shopping cart basket 114, see FIG. 1. Second bar clip 190 is the same type of coupler as first bar clip 170 and has the same description. Second bar clip 190 is coupled to first divider second end panel outer side 165 at first divider second end 144, see FIG. 3. Second bar clip 190 couples a rail or bar of shopping cart basket 114 to couple first divider 140, specifically first divider second end panel 160, to shopping cart 112. Second bar clip 190 is a rocker coupler having a rocker arm with a rocker handle at one end and a rocker head at the other end of the rocker arm and is coupled to first divider second end panel 160 where first divider second end panel outer side 165 meets first divider second end panel top side 163, see FIG. 3. The rocker head can be made to engage or disengage with shopping cart basket 114 by moving the rocker handle up or down, which moves the rocker head up or down against shopping cart basket 114. The rocker head has an outer semicircular shape and engages a rail such as top rail 128 when the rocker head is moved up towards the rail. The rocker head disengages from the rail by moving the rocker head down away from the rail.

First divider second end panel 160 has a second bottom plug coupler 193 to couple first divider 140, and specifically first divider second end panel 160, to shopping cart basket 114. Second bottom plug coupler 193 is the same as first bottom plug coupler 180 and has the same description. Second bottom plug coupler 193 is a block of elastic material, rubber, in this embodiment. Second bottom plug coupler 193 has five flat sides and one wavy side, the wavy side having three peaks and two valleys. Second bottom plug coupler 193 is coupled to first divider second end panel bottom side 164, see FIG. 3. Second bottom plug coupler 193 is sized so the center peak just barely fits through a second opening in shopping cart basket bottom 124. The center peak of second bottom plug coupler 193 fills the second opening and uses friction between second bottom plug coupler 193 and the rails surrounding the second opening to friction couple second bottom plug coupler 193 to shopping cart basket bottom 124. Second bottom plug coupler 193 is coupled to first divider second end panel bottom side 164 with its wavy side away from first divider second end panel bottom side 164. The wavy side provides second bottom plug coupler 193 the give needed to slip a portion of second bottom plug coupler 193, such as the center peak, through the second opening and couple first divider 140, specifically first divider second end panel 160, to shopping cart basket bottom 124, see FIG. 2.

First divider center panel 210 (FIG. 3, FIG. 7, and FIG. 8) is between first divider first end panel 150 and first divider second end panel 160. First divider first end panel 150 and first divider second end panel 160 are each hollow panels, as explained above. First divider center panel 210 is slidingly coupled to both first divider first end panel 150 and first divider second end panel 160, see FIG. 3. First divider center panel 210 is not hollow, but instead is sized, shaped, and configured to slide into and out of each one of first divider first end panel 150 and first divider second end panel 160. First divider center panel 210 sliding into and out of first divider first end panel 150 and first divider second end panel 160 adjusts first divider length 146, as shown in FIG. 3. FIG. 7 shows a front view of first divider center panel 210. FIG. 8 shows a side view of first divider center panel 210.

First divider center panel 210 is formed of a rectangular first divider center panel frame 212 and a first mesh panel 224. First divider center panel frame 212 is formed of four rigid sides that are bars, rods or plates in this embodiment, but this is not meant to be limiting. First divider center panel frame 212 surrounds an open first divider center panel center section 214, see FIG. 7. First divider center panel center section 214 is covered by, or filled with, first mesh panel 224. First mesh panel 224 is formed of a flexible mesh that covers first divider center panel center section 214. First mesh panel 224 is coupled to first divider center panel frame 212 so that first mesh panel 224 fills first divider center panel center section 214, as shown in FIG. 7. First mesh panel 224 can be an antibiotic or anti-mold treated mesh to keep divider system 110 sanitary.

First divider center panel frame 212 is a rectangular shaped frame with four sides that include a first divider center panel top bar 216, a first divider center panel bottom bar 218, a first divider center panel first side bar 220, and a first divider center panel second side bar 222. First divider center panel 210 slides into and out of first divider first end panel 150 through first divider first end panel inner side 156. First divider center panel 210 slides into and out of first divider second end panel 160 through first divider second end panel inner side 166. First divider center panel first side bar 220 slides into first divider first end cavity 157 through first divider first end panel opening 158 in first divider first end panel inner side 156 to couple first divider center panel 210 to first divider first end panel 150, see FIG. 3. First divider center panel second side bar 222 slides into the first divider second end cavity through the first divider second end panel opening in first divider second end panel inner side 166 to couple first divider center panel 210 to first divider second end panel 160, see FIG. 3. Sliding first divider center panel 210 into and out of first divider first end panel 150 adjusts first divider length 146. Sliding first divider center panel 210 into and out of first divider second end panel 160 adjusts first divider length 146.

First divider center panel top bar 216 is an elongate bar or panel of rigid material that is the top bar of rectangular first divider center panel frame 212. First divider center panel top bar 216 has a first divider center panel top bar longitudinal axis 217, a first divider center panel top bar front surface 226, a first divider center panel top bar bottom surface 231, and a first divider center panel top bar rear surface 230, see FIG. 8. First divider center panel top bar 216 has a mesh capture groove 234 in first divider center panel top bar bottom surface 231 that is configured to capture and hold first mesh panel 224, see FIG. 8.

First divider center panel top bar 216 has a first divider center panel top bar front groove 228 in first divider center panel top bar front surface 226. First divider center panel top bar front groove 228 is a V shaped groove or channel extending into first divider center panel top bar 216. First divider center panel top bar front groove 228 is located and configured to mate with front top ridge 172 of first divider first end panel 150 and the corresponding front top ridge of first divider second end panel 160. First divider center panel top bar front groove 228 has a top bar front groove longitudinal axis 229 that extends longitudinally along first divider center panel top bar front groove 228, see FIG. 7. Top bar front groove longitudinal axis 229 is parallel to first divider center panel top bar longitudinal axis 217, see FIG. 7. Front top ridge 172 of first divider first end panel 150 (FIG. 6) slides into and out of first divider center panel top bar front groove 228 in response to first divider center panel 210 sliding into and out of first divider first end panel 150, see FIG. 3. The corresponding front top ridge of first divider second end panel 160 slides into and out of first divider center panel top bar front groove 228 in response to first divider center panel 210 sliding into and out of first divider second end panel 160, see FIG. 3.

First divider center panel top bar 216 has a first divider center panel top bar rear groove 232 in first divider center panel top bar rear surface 230. First divider center panel top bar rear groove 232 is a V shaped groove or channel extending into first divider center panel top bar 216. First divider center panel top bar rear groove 232 is located and configured to mate with rear top ridge 272 of first divider first end panel 150 (FIG. 6) and the corresponding rear top ridge of first divider second end panel 160. First divider center panel top bar rear groove 232 has a top bar rear groove longitudinal axis that extends longitudinally along first divider center panel top bar rear groove 232. The top bar rear groove longitudinal axis is parallel to first divider center panel top bar longitudinal axis 217, see FIG. 7. Rear top ridge 272 of first divider first end panel 150 (FIG. 6) slides into and out of first divider center panel top bar rear groove 232 in response to first divider center panel 210 sliding into and out of first divider first end panel 150, see FIG. 3. The corresponding rear top ridge of first divider second end panel 160 slides into and out of first divider center panel top bar rear groove 232 in response to first divider center panel 210 sliding into and out of first divider second end panel 160, see FIG. 3.

First divider center panel bottom bar 218 is an elongate bar or panel of rigid material that is the bottom bar of rectangular first divider center panel frame 212, see FIG. 7. First divider center panel bottom bar 218 has a first divider center panel bottom bar front surface 236, a first divider center panel bottom bar top surface 244, and a first divider center panel bottom bar rear surface 240, see FIG. 8. First divider center panel bottom bar 218 has a mesh capture groove 235 in first divider center panel bottom bar top surface 244 that is configured to capture and hold first mesh panel 224, see FIG. 8.

First divider center panel bottom bar 218 has a first divider center panel bottom bar front groove 238 in first divider center panel bottom bar front surface 236, see FIG. 7 and FIG. 8. First divider center panel bottom bar front groove 238 is a V shaped groove or channel extending into first divider center panel bottom bar 218. First divider center panel bottom bar front groove 238 is located and configured to mate with front bottom ridge 175 of first divider first end panel 150 and the corresponding front bottom ridge of first divider second end panel 160. First divider center panel bottom bar front groove 238 has a bottom bar front groove longitudinal axis 239 that extends longitudinally along first divider center panel bottom bar front groove 238, see FIG. 7. Bottom bar front groove longitudinal axis 239 is parallel to first divider center panel top bar longitudinal axis 217, see FIG. 7. Front bottom ridge 175 of first divider first end panel 150 (FIG. 6) slides into and out of first divider center panel bottom bar front groove 238 in response to first divider center panel 210 sliding into and out of first divider first end panel 150, see FIG. 3. The corresponding front bottom ridge of first divider second end panel 160 slides into and out of first divider center panel bottom bar front groove 238 in response to first divider center panel 210 sliding into and out of first divider second end panel 160, see FIG. 3.

First divider center panel bottom bar 218 has a first divider center panel bottom bar rear groove 242 in first divider center panel bottom bar rear surface 240. First divider center panel bottom bar rear groove 242 is a V shaped groove or channel extending into first divider center panel bottom bar 218. First divider center panel bottom bar rear groove 242 is located and configured to mate with rear bottom ridge 275 of first divider first end panel 150 (FIG. 6) and the corresponding rear bottom ridge of first divider second end panel 160. First divider center panel bottom bar rear groove 242 has a bottom bar rear groove longitudinal axis that extends longitudinally along first divider center panel bottom bar rear groove 242. The bottom bar rear groove longitudinal axis is parallel to first divider center panel top bar longitudinal axis 217, see FIG. 7. Rear bottom ridge 275 of first divider first end panel 150 (FIG. 6) slides into and out of first divider center panel bottom bar rear groove 242 in response to first divider center panel 210 sliding into and out of first divider first end panel 150, see FIG. 3. The corresponding rear bottom ridge of first divider second end panel 160 slides into and out of first divider center panel bottom bar rear groove 242 in response to first divider center panel 210 sliding into and out of first divider second end panel 160, see FIG. 3.

First divider center panel first side bar 220 is an elongate bar or panel of rigid material that is one side bar of rectangular first divider center panel frame 212, see FIG. 7. First divider center panel first side bar 220 extends between, and is coupled to, both first divider center panel top bar 216 and first divider center panel bottom bar 218. First divider center panel first side bar 220 slides into first divider first end cavity 157 through first divider first end panel opening 158 to couple first divider center panel 210 to first divider first end panel 150.

First divider center panel second side bar 222 is an elongate bar of rigid material that is another side bar of rectangular first divider center panel frame 212, see FIG. 7. First divider center panel second side bar 222 extends between, and is coupled to, both first divider center panel top bar 216 and first divider center panel bottom bar 218. First divider center panel second side bar 222 slides into the first divider second end cavity through the first divider second end panel opening to couple first divider center panel 210 to first divider second end panel 160.

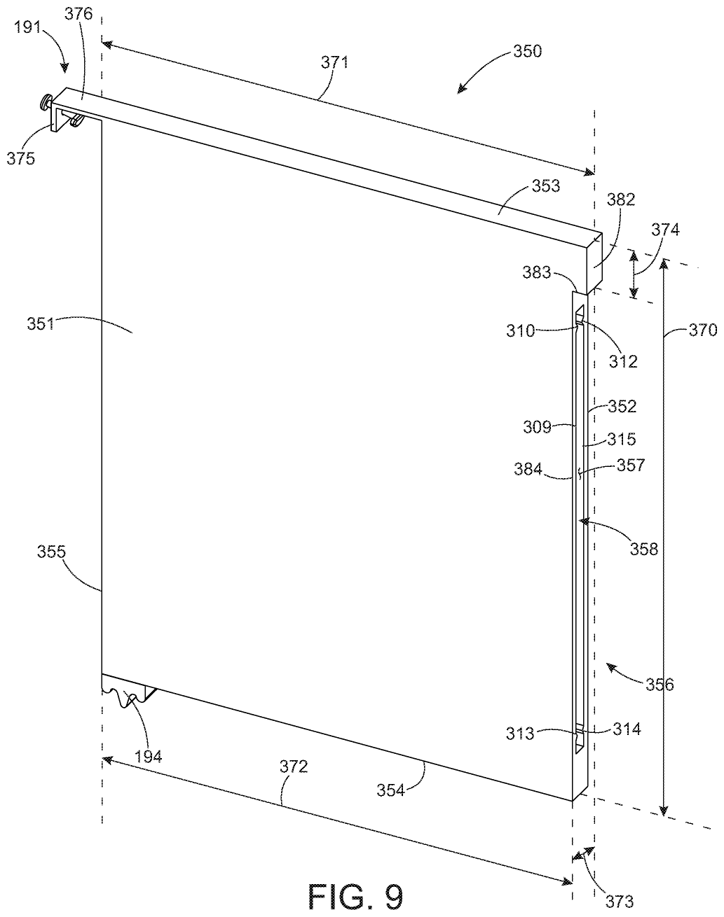

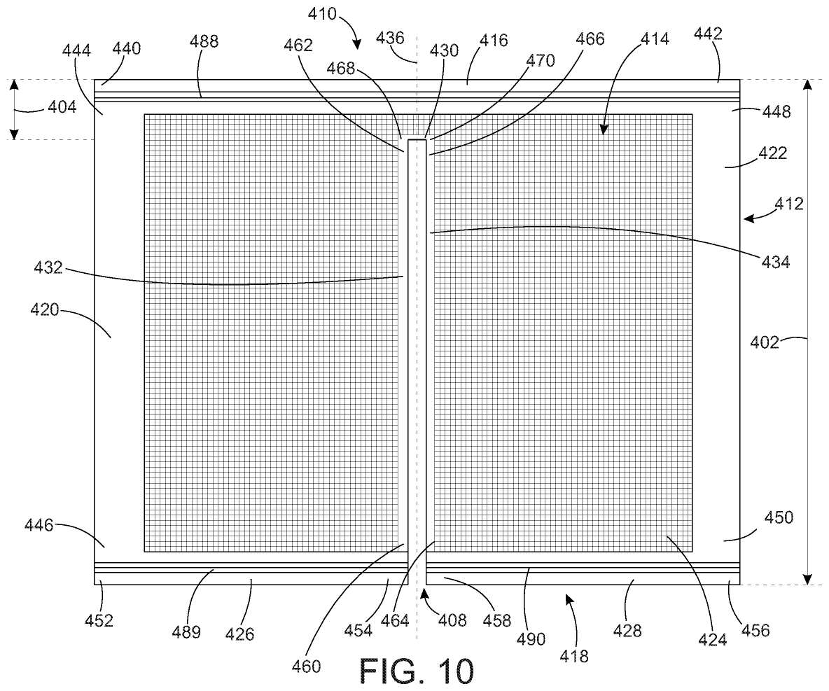

Second divider 340 removably couples to first divider 140 so that first divider 140 and second divider 340 form a cross or an X in top view, see FIG. 1 and FIG. 3. FIG. 9 and FIG. 10 show additional details of second divider 340. Second divider 340 has second divider first end 342 and second divider second end 344 opposing second divider first end 342, see FIG. 3. Second divider 340 includes second divider first end panel 350, second divider second end panel 360, and second divider center panel 410, see FIG. 3. FIG. 9 shows a front perspective view of second divider first end panel 350. FIG. 10 shows a front view of second divider center panel 410. Second divider center panel 410 has a slot 408 (FIG. 10) which allows second divider center panel 410 to slide over first divider center panel 210 to removably couple second divider 340 to first divider 140, as shown in FIG. 3. Slot 408 is a slot opening that opens to a bottom edge 418 of second divider center panel 410. Second divider 340 slidingly sets on first divider 140, see FIG. 3. Slot 408 allows second divider 340 to set on and slide along the top of first divider 140. Second divider 340 sliding along first divider 140 adjusts the size of the compartments in shopping cart basket 114.

Second divider first end panel 350, as shown in FIG. 9, is a hollow panel having a second divider first end front plate 351, and a second divider first end rear plate 352. Second divider first end front plate 351 and second divider first end rear plate 352 are each flat plates of rigid material which have a six-sided polygon shape in front view. A second divider first end cavity 357 is between second divider first end front plate 351 and second divider first end rear plate 352.

Second divider first end front plate 351 and second divider first end rear plate 352 are held spaced from one another by a second divider first end panel top side 353, a second divider first end panel bottom side 354, a second divider first end panel outer side 355 at second divider first end 342, and a second divider first end panel inner side 356 opposing second divider first end panel outer side 355.

Second divider first end panel inner side 356 has an opening through it to allow second divider center panel 410 to slide into and out of second divider first end panel inner side 356, see FIG. 3 and FIG. 9. Second divider first end panel inner side 356 has a second divider height 370, see FIG. 9. Second divider first end panel inner side 356 has a second divider first end panel opening 358 through second divider first end panel inner side 356, see FIG. 9. Second divider first end panel opening 358 is through second divider first end panel inner side 356 to allow access to second divider first end panel cavity 357. Second divider center panel 410 slides into and out of second divider first end cavity 357 of second divider first end panel 350 through second divider first end panel opening 358.

Second divider first end panel outer side 355 is a rectangular panel, or bar, of rigid material that forms an outer side to second divider first end panel 350. Second divider first end panel outer side 355 has second divider height 370, see FIG. 9. Second divider first end panel bottom side 354 is a rectangular panel or bar of rigid material that forms a bottom side to second divider first end panel 350. Second divider first end panel top side 353 is a rectangular panel or bar of rigid material that forms a top side to second divider first end panel 350.

Second divider first end panel inner side 356 is formed of three rectangular sections, second divider first section 382, second divider second section 383, and second divider third section 384, see FIG. 9, which are each elongate rectangular bars, rods, or plates. Second divider first end panel inner side 356 is divided into three second divider sections 382, 383, and 384 so that second divider first end panel inner side 356 can be “stepped”. Second divider first end panel inner side 356 is stepped so that second divider first end panel 350 and second divider second end panel 360 will not cover slot 408 when second divider first end panel 350 and second divider second end panel 360 are slid fully towards each other. Second divider first section 382 is coupled to and perpendicular to second divider first end panel top side 353. Second divider first section 382 is parallel to second divider first end panel outer side 355 and is spaced apart from second divider first end panel outer side 355 by a first divider first end panel top side length 371. Second divider first section 382 has a second divider first section height 374.

Second divider first section height 374 (FIG. 9) is equal to first section height 187 (FIG. 4) and first divider first end panel height 183 is equal to second divider first end panel height 370 so that first divider 140 and second divider 340 have the same height above shopping cart basket bottom 124 in shopping cart 112 when second divider 340 is setting on top of, and coupled to, first divider 140.

Second divider third section 384 is coupled to and perpendicular to second divider first end panel bottom side 354. Second divider third section 384 is parallel to second divider first end panel outer side 355 and is spaced apart from second divider first end panel outer side 355 by a second divider first end panel bottom side length 372. Second divider second section 383 extends between second divider first section 382 and second divider third section 384, and is coupled to both second divider first section 382 and second divider third section 384. Second divider third section 383 is parallel to both second divider first end panel top side 353 and second divider first end panel bottom side 354. Second divider third section 383 has a length 373, see FIG. 9.

Second divider first end front plate 351 and second divider first end rear plate 352 are spaced apart from one another, with second divider first end cavity 357 in between. Second divider center panel 410 slides into and out of second divider first end cavity 357. Second divider first end front plate 351 and second divider first end rear plate 352 have ridges on their inner surface that mate with grooves on an outer surface of second divider center panel 410 to guide second divider center panel 410 into and out of second divider first end cavity 357.

Second divider first end front plate 351 has two ridges, a second divider front top ridge 310 and a second divider front bottom ridge 313 extending or protruding from a second divider first end front plate inner surface 309. Second divider front top ridge 310 and second divider front bottom ridge 313 are each triangular shape protrusions with straight longitudinal axes. Second divider front top ridge 310 and second divider front bottom ridge 313 and their respective longitudinal axes each extend from second divider first end panel inner side 356 to second divider first end panel outer side 355. Second divider front top ridge 310 and second divider front bottom ridge 313 have longitudinal axes that are parallel to second divider first end panel bottom side 354, see FIG. 9. Second divider front top ridge 310 is positioned closer to second divider first end panel top side 353 than second divider first end panel bottom side 354. Second divider front bottom ridge 313 is positioned closer to second divider first end panel bottom side 354 than second divider first end panel top side 353.

Second divider first end rear plate 352 has a second divider first end rear plate inner surface 315, see FIG. 9. Second divider first end rear plate 352 has two ridges, a second divider rear top ridge 312 and a second divider rear bottom ridge 314 extending or protruding from second divider first end rear plate inner surface 315. Second divider rear top ridge 312 and second divider rear bottom ridge 314 are each triangular shape protrusions with straight longitudinal axes. Second divider rear top ridge 312 and second divider rear bottom ridge 314 and their respective longitudinal axes each extend from second divider first end panel inner side 356 to second divider first end panel outer side 355. Second divider rear top ridge 312 and second divider rear bottom ridge 314 have longitudinal axes that are parallel to second divider first end panel bottom side 354, see FIG. 9. Second divider rear top ridge 312 is positioned closer to second divider first end panel top side 353 than second divider first end panel bottom side 354. Second divider rear bottom ridge 314 is positioned closer to second divider first end panel bottom side 354 than second divider first end panel top side 353.

Second divider first end panel 350 also includes a third bar clip 191. Third bar clip 191 is used to couple second divider 340, specifically second divider first end panel 350, to top rail 128 or another rail or bar of shopping cart basket 114, see FIG. 1. Third bar clip 191 is coupled to second divider first end panel outer side 355 at second divider first end 342. Third bar clip 191 couples to top rail 128 or another rail of shopping cart basket 114 to couple second divider 340, specifically second divider first end panel 350, to shopping cart 112. Third bar clip 191 is the same as first bar clip 170 and second bar clip 190. Third bar clip 191 is a rocker coupler having a rocker arm with a rocker handle at one end and a rocker head at the other end of the rocker arm. The rocker arm is tiltingly coupled to a second divider side plate 375 such that the rocker arm extends through second divider side plate 375, with the rocker head on one side of second divider side plate 375 and the rocker handle on the other side of second divider side plate 375. The rocker handle is pushed up and down to move the rocker head up and down. Moving the rocker head up and down engages and disengages third bar clip 191 with top rail 128 or another rail or bar of shopping cart basket 114 to couple and uncouple second divider 340 to top rail 128.

A second divider top plate 376, a flat rectangular plate of rigid material, is coupled to second divider first end panel outer side 355 at the junction of second divider first end panel outer side 355 and second divider first end panel top side 353. Second divider top plate 376 extends from, and lies in the same plane as, second divider first end panel top side 353. Second divider first end panel 350 is coupled to shopping cart basket 114 by first setting second divider top plate 376 on a rail of shopping cart basket 114. Second divider side plate 375 extends from second divider top plate 376 such that second divider side plate 375 is perpendicular to second divider top plate 376 and parallel to second divider first end panel outer side 355. Second divider side plate 375 holds third bar clip 191 a spaced distance from second divider first end panel outer side 355. When second divider top plate 376 is hung on a rail or bar, the rocker head of third bar clip 191 can be made to engage or disengage with the rail to couple or uncouple third bar clip 191 and second divider first end panel 350 to the rail, such as top rail 128, for example, as explained for first bar clip 170. The rocker head of third bar clip 191 has an outer semicircular shape and engages the rail or bar when the rocker head is moved up towards top plate 376. The rocker head disengages from the rail by moving the rocker head down away from top plate 376.

Third bar clip 191 is one of two bar clips used to couple and uncouple second divider 340 to shopping cart basket 114. Fourth bar clip 192 is coupled to second divider second end panel 360 and similarly couples and uncouples second divider second end panel 360 to top rail 128, see FIG. 1 and FIG. 3, or another rail or bar of shopping cart basket 114 of shopping cart 112.

Second divider first end panel 350 has a third bottom plug coupler 194 to couple second divider 340, and specifically second divider first end panel 350, to shopping cart basket 114. Third bottom plug coupler 194 is the same as first bottom plug coupler 180 and has the same description. Third bottom plug coupler 194 is a block of elastic material, rubber, in this embodiment. Third bottom plug coupler 194 has five flat sides and one wavy side, the wavy side having three peaks and two valleys. Third bottom plug coupler 194 is coupled to second divider first end panel bottom side 354, see FIG. 9. Third bottom plug coupler 194 is sized so the center peak just barely fits through a third opening in shopping cart basket bottom 124. The center peak of third bottom plug coupler 194 fills the third opening and uses friction between third bottom plug coupler 194 and the rails surrounding the third opening to friction couple third bottom plug coupler 194 to shopping cart basket bottom 124. Third bottom plug coupler 194 is coupled to second divider first end panel bottom side 354 with its wavy side away from second divider first end panel bottom side 354. The wavy side provides third bottom plug coupler 194 the give needed to slip a portion of third bottom plug coupler 194, such as the center peak of third bottom plug coupler 194, for example, through the third opening and couple second divider 340, specifically second divider first end panel 350, to shopping cart basket bottom 124, see FIG. 2

Third bottom plug coupler 194 is one of two bottom plug couplers used to couple and uncouple second divider 340 to shopping cart basket 114. Fourth bottom plug coupler 195 is coupled to second divider second end panel 360 and similarly couples and uncouples second divider second end panel 360 to shopping cart basket bottom 124, see FIG. 2.

Second divider second end panel 360 is a mirror image of second divider first end panel 350, as best seen in FIG. 3. Second divider second end panel 360 is a hollow panel having a second divider second end front plate 361, and a second divider second end rear plate, not shown. Second divider second end front plate 361 and the second divider second end rear plate are each flat plates of rigid material which have a six-sided polygon shape in front view. A second divider second end cavity is between second divider second end front plate 361 and the first divider second end rear plate.

Second divider second end front plate 361 and the second divider second end rear plate are held spaced from one another by a second divider second end panel top side 363, a second divider second end panel bottom side (not shown), a second divider second end panel outer side 365 at second divider second end 344, and a second divider second end panel inner side 366 opposing second divider second end panel outer side 365.

Second divider second end panel inner side 366 is a rectangular panel with an opening through it to allow second divider center panel 410 to slide into and out of second divider second end panel inner side 366. Second divider second end panel inner side 366 mirrors second divider first end panel inner side 356, see FIG. 9. Second divider second end panel inner side 366 has a second divider second end panel opening (not seen in figures) through second divider second end panel inner side 366. The second divider second end panel opening is through second divider second end panel inner side 366 to allow access to the second divider second end panel cavity. Second divider center panel 410 slides into and out of the second divider second end cavity of second divider second end panel 360 through the second divider second end panel opening.

Second divider second end panel outer side 365 is a rectangular panel of rigid material that forms an outer side to second divider second end panel 360. Second divider second end panel outer side 365 has a second divider second end panel outer side height that is equal to second divider first end panel outer side height 370. The second divider second end panel bottom side is a rectangular panel of rigid material that forms a bottom side to second divider second end panel 360. Second divider second end panel top side 363 is a rectangular panel or bar of rigid material that forms a top side to second divider second end panel 360.

Second divider second end panel inner side 366 is formed of three rectangular sections, mirroring second divider first end panel inner side 356, see FIG. 9. Second divider second end panel inner side 356 has a second divider second end panel inner side height equal to second divider first end panel inner side height 370, see FIG. 9.

Second divider second end front plate 361 and the second divider second end rear plate are spaced apart from one another, with the second divider second end cavity in between. Second divider center panel 410 slides into and out of the second divider second end cavity, see FIG. 3. Second divider second end front plate 361 and the second divider second end rear plate have ridges on their inner surface that mirror the ridges on second divider first end front plate 351 and second divider first end rear plate 352, see FIG. 9. The ridges mate with grooves on an outer surface of second divider center panel 410 to guide second divider center panel 410 into and out of the second divider second end cavity, just as explained for second divider first end panel 350.

Second divider second end panel 360 includes a fourth bar clip 192. Fourth bar clip 192 is used to couple second divider 340, specifically second divider second end panel 360, to top rail 128, or another rail or bar of shopping cart basket 114, see FIG. 1. Fourth bar clip 192 is the same type of coupler as first, second, and third bar clips 170, 190, and 191 and has the same description. Fourth bar clip 192 is coupled to second divider second end panel outer side 365 at second divider second end 344, see FIG. 3. Fourth bar clip 192 couples to a rail of shopping cart basket 114 to couple second divider 340, specifically second divider second end panel 360, to shopping cart 112. Fourth bar clip 192 is a rocker coupler having a rocker arm with a rocker handle at one end and a rocker head at the other end of the rocker arm, and is coupled to second divider second end panel 360 where second divider second end panel outer side 365 meets second divider second end panel top side 363, see FIG. 3. The rocker head can be made to engage or disengage with top rail 128 or another rail of shopping cart basket 114 by tilting the rocker handle, which moves the rocker head up or down against top rail 128. The rocker head has an outer semicircular shape and engages top rail 128 when the rocker head is moved up towards top rail 128. The rocker head disengages from top rail 128 by moving the rocker head down away from top rail 128.

Second divider second end panel 360 has a fourth bottom plug coupler 195 to couple second divider 340, and specifically second divider second end panel 360, to shopping cart basket 114. Fourth bottom plug coupler 195 is the same as first bottom plug coupler 180 and has the same description. Fourth bottom plug coupler 195 is a block of elastic material, rubber, in this embodiment. Fourth bottom plug coupler 195 has five flat sides and one wavy side, the wavy side having three peaks and two valleys. Fourth bottom plug coupler 195 is coupled to the second divider second end panel bottom side, see FIG. 2. Fourth bottom plug coupler 195 is sized so the center peak just barely fits through a fourth opening in shopping cart basket bottom 124. The center peak of fourth bottom plug coupler 195 fills the fourth opening and uses friction between fourth bottom plug coupler 195 and the rails surrounding the fourth opening to friction couple fourth bottom plug coupler 195 to shopping cart basket bottom 124. Fourth bottom plug coupler 195 is coupled to the second divider second end panel bottom side with its wavy side away from the second divider second end panel bottom side. The wavy side provides fourth bottom plug coupler 195 the give needed to slip the center peak of fourth bottom plug coupler 195 through the fourth opening and couple second divider 340, specifically second divider second end panel 360, to shopping cart basket bottom 124, see FIG. 2.

Second divider center panel 410 (FIG. 3 and FIG. 10) is between second divider first end panel 350 and second divider second end panel 360. Second divider first end panel 350 and second divider second end panel 360 are each hollow panels, as explained above. Second divider center panel 410 is slidingly coupled to both second divider first end panel 350 and second divider second end panel 360, see FIG. 3. Second divider center panel 410 is not hollow. Second divider center panel 410 is sized, shaped, and configured to slide into and out of each one of second divider first end panel 350 and second divider second end panel 360. Second divider center panel 410 sliding into and out of second divider first end panel 350 and second divider second end panel 360 adjusts second divider length 346, as shown in FIG. 3. FIG. 10 shows a front view of second divider center panel 410.

Second divider center panel 410, similar to first divider center panel 210, is formed of a frame surrounding a center section, where the center section is filled with a mesh panel. Second divider center panel 410 is formed of a second divider center panel frame 412. Second divider center panel frame 412 is shape somewhat like an upside down “U” because second divider center panel frame 412 has a generally rectangular outer shape with a slot 408 extending upwards into the frame from the bottom panel and towards the top panel. Second divider center panel frame 412 is formed of eight rigid sides that are plates, bars or rods in this embodiment, but this is not meant to be limiting. Second divider center panel frame 412 surrounds a second divider center panel center section 414, see FIG. 10. Second divider center panel center section 414 is covered by, or filled with, a second mesh panel 424. Second mesh panel 424 is formed of a flexible mesh that covers second divider center panel center section 414. Second mesh panel 424 is coupled to second divider center panel frame 412 so that second mesh panel 424 fills second divider center panel center section 414, as shown in FIG. 10. Second mesh 424 can be an antibiotic or anti-mold treated mesh to keep divider system 110 sanitary.

Second divider center panel frame 412 is in the shape of an eight-sided polygon, see FIG. 10. Second divider center panel frame 412 has a second divider center panel top bar 416 having a top bar first end 440 and a top bar second end 442. Second divider center panel top bar 416 is an elongate plate, bar or rod formed of rigid material. Second divider center panel frame 412 has a second divider center panel bottom edge 418 opposing second divider center panel top bar 416. Second divider center panel frame 412 has a second divider center panel first side bar 420 and a second divider center panel second side bar 422 opposing second divider center panel first side bar 420. Second divider center panel frame 412 has a slot 408 that opens to second divider center panel frame bottom edge 418 and extends along a second divider centerline 436 into second divider center panel 410 towards second divider center panel top bar 416. Second divider centerline 436 extends from second divider center panel top bar 416 to second divider center panel bottom edge 418 halfway between second divider center panel first side bar 420 and second divider center panel second side bar 422.

Second divider center panel first side bar 420 is an elongate bar or rod formed of rigid material. Second divider center panel first side bar 420 has a first side bar first end 444 and a first side bar second end 446 opposing first side bar first end 444. First side bar first end 444 is coupled to top bar first end 440. Second divider center panel first side bar 420 is perpendicular to second divider center panel top bar 416. Second divider center panel second side bar 420 slides into second divider first end cavity 357 through second divider first end panel opening 358 to couple second divider center panel 410 to second divider first end panel 350.

Second divider center panel second side bar 422 is an elongate plate, bar or rod formed of rigid material. Second divider center panel second side bar 422 has a second side bar first end 448 and a second side bar second end 450 opposing second side bar first end 448. Second side bar first end 448 is coupled to top bar second end 442. Second divider center panel second side bar 422 is perpendicular to second divider center panel top bar 416. Second divider center panel second side bar 422 is parallel to second divider center panel first side bar 420. Second divider center panel second side bar 422 slides into the second divider second end cavity through the second divider second end panel opening to couple second divider center panel 410 to second divider second end panel 360.

Second divider center panel bottom edge 418 is divided into two separate bars because slot 408 opens to second divider center panel bottom edge 418, dividing second divider center panel bottom edge 418 into two separate bars. Second divider center panel 410 includes a second divider center panel first bottom bar 426 and a second divider center panel second bottom bar 428.

Second divider center panel first bottom bar 426 is an elongate bar or rod of rigid material with a first bottom bar first end 452 and a first bottom bar second end 454 opposing first bottom bar first end 452. First bottom bar first end 452 is coupled to first side bar second end 446. Second divider center panel first bottom bar 426 is perpendicular to second divider center panel first side bar 420 and parallel to second divider center panel top bar 416.

Second divider center panel second bottom bar 428 is an elongate bar or rod of rigid material with a second bottom bar first end 456 and a second bottom bar second end 458 opposing second bottom bar first end 456. Second bottom bar first end 456 is coupled to second side bar second end 450. Second divider center panel second bottom bar 428 is perpendicular to second divider center panel second side bar 422 and parallel to second divider center panel top bar 416.

Slot first side bar 432, slot second side bar 434, and slot top bar 430 define and bound slot 408. Slot first side bar 432 is an elongate bar of rigid material with a slot first side bar first end 460 and a slot first side bar second end 462. Slot first side bar first end 460 is coupled to first bottom bar second end 454. Slot first side bar 432 is perpendicular to second divider center panel first bottom bar 426 and parallel to second divider center panel first side bar 420. Slot first side bar 432 extends from slot first side bar first end 460 to slot first side bar second end 462 in a direction towards second divider center panel top bar 416.

Slot second side bar 434 is an elongate bar of rigid material with a slot second side bar first end 464 and a slot second side bar second end 466. Slot second side bar first end 464 is coupled to second bottom bar second end 458. Slot second side bar 434 is perpendicular to second divider center panel second bottom bar 428 and parallel to second divider center panel second side bar 422. Slot second side bar 434 extends from slot second side bar first end 464 to slot second side bar second end 466 in a direction towards second divider center panel top bar 416.

Slot top bar 430 defines the top end of slot 408. Slot 408 is a slot opening in second divider center panel 410 that opens to second divider center panel bottom edge 418. Slot top bar 430 is an elongate bar or rod of rigid material with a slot top bar first end 468 and a slot top bar second end 470. Slot top bar first end 468 is coupled to slot first side bar second end 462. Slot top bar second end 470 is coupled to slot second side bar second end 466. Slot top bar 430 is perpendicular to both slot first side bar 432 and slot second side bar 434. Slot top bar 430 is parallel to second divider center panel top bar 416, second divider center panel first bottom bar 426 and second divider center panel second bottom bar 428.

Slot 408 is sized to fit first divider center panel 210 into slot 408. First divider center panel 210 removably slides into slot 408 to couple first divider 140 to second divider 340, see FIG. 1 and FIG. 3. Slot top bar 430 sets on first divider center panel top bar 216 in response to second divider 340 being coupled to first divider 140. Slot top bar 430 slides along first divider center panel top bar 216 to adjust the position of second divider 340 in relation to first divider 140, which adjusts the size of the compartments formed by divider system 210 in shopping cart 112.

Second divider center panel 410 slides into and out of second divider first end panel 350 through second divider first end panel inner side 356. Second divider center panel 410 slides into and out of second divider second end panel 360 through second divider second end panel inner side 366. Second divider center panel first side bar 420 slides into second divider first end cavity 357 through second divider first end panel opening 358 in second divider first end panel inner side 356 to couple second divider center panel 410 to second divider first end panel 350, see FIG. 3. Second divider center panel second side bar 422 slides into the second divider second end cavity through the second divider second end panel opening in second divider second end panel inner side 366 to couple second divider center panel 410 to second divider second end panel 360, see FIG. 3. Sliding second divider center panel 410 into and out of second divider first end panel 350 adjusts second divider length 346. Sliding second divider center panel 410 into and out of second divider second end panel 360 adjusts second divider length 346.

Second divider center panel top bar 416 has a second divider center panel top bar front groove 488 in a front surface of second divider center panel top bar 416 (see FIG. 10), and a corresponding second divider center panel top bar rear groove on a rear surface of second divider center panel top bar 416 (not shown). Second divider center panel top bar front groove 488 is a V shaped groove or channel extending into second divider center panel top bar 416. Second divider center panel top bar front groove 488 is located and configured to mate with second divider front top ridge 310 of second divider first end panel 350 and the corresponding front top ridge of second divider second end panel 360. Second divider center panel top bar front groove 488 extends longitudinally along second divider center panel top bar 416 from center panel top bar first end 440 to top bar second end 442, see FIG. 10. Second divider center panel top bar front groove 488 is parallel to slot top bar 430, see FIG. 10. Second divider front top ridge 310 of second divider first end panel 350 (FIG. 9) slides into and out of second divider center panel top bar front groove 488 in response to second divider center panel 410 sliding into and out of second divider first end panel 350, see FIG. 3. The corresponding front top ridge of second divider second end panel 360 slides into and out of second divider center panel top bar front groove 488 in response to second divider center panel 410 sliding into and out of second divider second end panel 360, see FIG. 3.

The second divider center panel top bar rear groove is a V shaped groove or channel extending into second divider center panel top bar 416. The second divider center panel top bar rear groove is located and configured to mate with second divider rear top ridge 312 of second divider first end panel 350 (FIG. 9) and the corresponding rear top ridge of second divider second end panel 360. Second divider rear top ridge 312 of second divider first end panel 350 (FIG. 9) slides into and out of the second divider center panel top bar rear groove in response to second divider center panel 410 sliding into and out of second divider first end panel 350. The corresponding rear top ridge of second divider second end panel 360 slides into and out of the second divider center panel top bar rear groove in response to second divider center panel 410 sliding into and out of second divider second end panel 360, see FIG. 3.

Second divider center panel first bottom bar 426 has a second divider center panel first bottom bar front groove 489 in a front surface of second divider center panel first bottom bar 426, see FIG. 10. Second divider center panel first bottom bar front groove 489 is a V shaped groove or channel extending into second divider center panel first bottom bar 426. Second divider center panel first bottom bar front groove 489 is located and configured to mate with second divider front bottom ridge 313 of second divider first end panel 350. Second divider front bottom ridge 313 of second divider first end panel 350 (FIG. 9) slides along second divider center panel first bottom bar front groove 489 in response to second divider center panel 410 sliding into and out of second divider first end panel 350, see FIG. 3.

Second divider center panel first bottom bar 426 has a second divider center panel first bottom bar rear groove (not shown, mirror image of groove 489) in a rear surface of second divider center panel first bottom bar 426, see FIG. 10. The second divider center panel first bottom bar rear groove is a V shaped groove or channel extending into second divider center panel first bottom bar 426. The second divider center panel first bottom bar rear groove is located and configured to mate with second divider rear bottom ridge 314 of second divider first end panel 350 (FIG. 9). Second divider rear bottom ridge 314 of second divider first end panel 350 slides into and out of the second divider center panel first bottom bar rear groove in response to second divider center panel 410 sliding into and out of second divider first end panel 350, see FIG. 3.

Second divider center panel second bottom bar 428 has a second divider center panel second bottom bar front groove 490 in a front surface of second divider center panel second bottom bar 428, see FIG. 10. Second divider center panel second bottom bar front groove 490 is a V shaped groove or channel extending into second divider center panel second bottom bar 428. Second divider center panel second bottom bar front groove 490 is located and configured to mate with a second divider front bottom ridge of second divider second end panel 360. The second divider front bottom ridge of second divider second end panel 360 slides along second divider center panel second bottom bar front groove 490 in response to second divider center panel 410 sliding into and out of second divider second end panel 360, see FIG. 3.

Second divider center panel second bottom bar 428 has a second divider center panel second bottom bar rear groove (not shown, mirror image of groove 490) in a rear surface of second divider center panel second bottom bar 428, see FIG. 10. The second divider center panel second bottom bar rear groove is a V shaped groove or channel extending into second divider center panel second bottom bar 428. The second divider center panel second bottom bar rear groove is located and configured to mate with a second divider rear bottom ridge of second divider second end panel 360 (FIG. 3). The second divider rear bottom ridge of second divider second end panel 360 slides into and out of the second divider center panel second bottom bar rear groove in response to second divider center panel 410 sliding into and out of second divider second end panel 360, see FIG. 3.

A divider system has been shown and described that divides a shopping cart basket into multiple compartments so that items in the shopping basket can be kept separate from each other. The divider system includes a first divider and a second divider that removably couple to one another using a slot in the second divider. The first divider and the second divider are each flat elongate panel assemblies of multiple flat panel structures. The first divider is formed of three flat panels, two outer hollow panels and a center panel that slides into and out of each of the two hollow outer panels. The second divider is formed of three flat panels, two hollow outer panels and a center panel that slides into and out of each hollow outer panel. The center panel of the second divider has a slot that the first divider fits into to couple the first divider to the second divider. The center panels slide into and out of the hollow outer panels to adjust the length of the first and the second dividers. Ridges and grooves help couple and guide the center panels sliding into and out of the hollow outer panels. A set of four bar clips couple the divider system to the shopping cart. A set of four bottom plug couplers also couple the divider to the shopping cart. With the divider system inserted into the basket of a shopping cart and coupled to the shopping cart, the divider system divides the shopping basket into multiple compartments for dividing items in the shopping basket. The second divider can be slid along the top of the first divider to adjust the size of the multiple compartments. The first or the second divider can be used alone to divide the shopping basket into fewer compartments.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. A divider system for a shopping cart, the divider system comprising:
a first divider having an adjustable first divider length, the first divider comprising:
a hollow first divider first end panel comprising:
a first divider first end front plate;
a first divider first end rear plate spacedly coupled to the first divider first end front plate;
a first divider first end cavity between the first divider first end front plate and the first divider first end rear plate; and
a first divider first end panel opening into the first divider first end cavity through a first divider first end panel inner side;
a hollow first divider second end panel comprising:
a first divider second end front plate;
a first divider second end rear plate spacedly coupled to the first divider second end front plate;
a first divider second end cavity between the first divider second end front plate and the first divider second end rear plate; and
a first divider second end panel opening into the first divider second end cavity through a first divider second end panel inner side; and
a first divider center panel slidingly coupled to both the first divider first end panel and the first divider second end panel, wherein the first divider center panel comprises:
a rectangular first divider center panel frame surrounding a first divider center panel center section, wherein the first divider center panel frame comprises:
a first divider center panel top bar;
a first divider center panel bottom bar;
a first divider center panel first side bar coupled to, and extending between, the first divider center panel top bar and the first divider center panel bottom bar, wherein the first divider center panel first side bar slides into the first divider first end cavity through the first divider first end panel opening to couple the first divider center panel to the first divider first end panel; and
a first divider center panel second side bar coupled to, and extending between, the first divider center panel top bar and the first divider center panel bottom bar, wherein the first divider center panel second side bar slides into the first divider second end cavity through the first divider second end panel opening to couple the first divider center panel to the first divider second end panel; and
a first mesh panel coupled to the first divider center panel frame, wherein the first mesh panel covers the first divider center panel center section;
and
a second divider removably coupled to the first divider, wherein the second divider has an adjustable second divider length, and wherein the second divider comprises:
a hollow second divider first end panel comprising:
a second divider first end front plate;
a second divider first end rear plate spacedly coupled to the second divider first end front plate;
a second divider first end cavity between the second divider first end front plate and the second divider first end rear plate; and
a second divider first end panel opening into the second divider first end cavity through a second divider first end panel inner side;
a hollow second divider second end panel comprising:
a second divider second end front plate;
a second divider second end rear plate spacedly coupled to the second divider second end front plate;
a second divider second end cavity between the second divider second end front plate and the second divider second end rear plate; and
a second divider second end panel opening into the second divider second end cavity through a second divider second end panel inner side edge; and
a second divider center panel slidingly coupled to both the second divider first end panel and the second divider second end panel, wherein the second divider center panel comprises a slot, wherein the slot opens to a second divider center panel bottom edge and extends into the second divider center panel towards a second divider center panel top bar, and wherein the first divider center panel slides into the slot to couple the first divider to the second divider.

2. The divider system of claim 1, wherein the second divider center panel comprises an eight-sided second divider center panel frame surrounding a second divider center panel center section, wherein the second divider center panel frame comprises:
the second divider center panel top bar having a second divider center panel top bar first end and a second divider center panel top bar second end;
a second divider center panel first side bar coupled to and extending perpendicularly from the second divider center panel top bar first end;
a second divider center panel first bottom bar coupled to and extending perpendicularly from the second divider center panel first side bar;
a second divider center panel second side bar coupled to and extending perpendicularly from the second divider center panel top bar second end;
a second divider center panel second bottom bar coupled to and extending perpendicularly from the second divider center panel second side bar;
a slot first side bar coupled to and extending perpendicularly from the second divider center panel first bottom bar;
a slot second side bar coupled to and extending perpendicularly from the second divider center panel second bottom bar;
a slot top bar coupled to and extending perpendicularly from both the slot first side bar and the slot second side bar, wherein the slot top bar is parallel to the second divider center panel top bar;
and
a second mesh panel coupled to the second divider center panel frame, wherein the second mesh panel covers the second divider center panel center section.

3. The divider system of claim 2, wherein the slot top bar sets on the first divider center panel top bar in response to the second divider being coupled to the first divider.

4. The divider system of claim 2, wherein the second divider center panel first side bar slides into and out of the second divider first end cavity through the second divider first end panel opening to adjust the second divider length.

5. The divider system of claim 1, wherein sliding the first divider center panel into and out of the first divider first end panel adjusts the first divider length.

6. The divider system of claim 1, wherein the first divider first end front plate has a six-sided polygon shape in front view.

7. The divider system of claim 1, wherein the first divider second end panel is a mirror image of the first divider first end panel.

8. The divider system of claim 2, wherein the slot extends along a second divider center panel centerline.

9. The divider system of claim 2, wherein the second divider center panel has an eight-sided polygon shape in front view.

10. The divider system of claim 1, wherein the first divider has a first divider first end and a first divider second end opposing the first divider first end, and wherein the first divider first end panel further comprises:
a first divider first end panel top side;
a first divider first end panel bottom side;
a first divider first end panel outer side;
the first divider first end panel inner side;
a first bar clip coupled to the first divider first end panel outer side at the first divider first end; and
a first bottom plug coupler coupled to the first divider first end panel bottom side, wherein the first bottom plug coupler extends through a first opening in a shopping cart basket bottom of a shopping cart.

11. The divider system of claim 10, wherein the first divider second end panel further comprises:
a first divider second end panel top side;
a first divider second end panel bottom side;
a first divider second end panel outer side;
the first divider second end panel inner side;
a second bar clip coupled to the first divider second end panel outer side at the first divider panel second end, wherein the second bar clip couples to the top rail; and
a second bottom plug coupler, wherein the second bottom plug coupler comprises a center peak that extends through a second opening in the shopping cart basket bottom to friction couple the first divider to the shopping cart basket, and wherein the second bottom plug coupler center peak fills the second opening in response to the second bottom plug coupler center peak extending through the second opening.

12. A combination shopping cart and divider system, the combination comprising:
a shopping cart having a shopping cart basket, wherein the shopping cart basket comprises:
a shopping cart basket bottom formed of a lattice of rails;
four shopping cart basket sides coupled to the shopping car bottom;
a shopping cart basket open top; and
a top rail coupled to each of the four shopping basket sides, wherein the top rail encircles the shopping cart basket open top;
a first divider having a first divider first end and a first divider second end opposing the first divider first end, wherein the first divider comprises:
a hollow first divider first end panel having a first divider first end front plate and a first divider first end rear plate spacedly coupled to the first divider first end front plate by a first divider first end panel top side, a first divider first end panel bottom side, a first divider first end panel outer side and a first divider first end panel inner side, wherein the first divider first end panel comprises:
a first bar clip coupled to the first divider first end panel outer side at the first divider first end, wherein the first bar clip couples to the top rail; and
a first bottom plug coupler, wherein the first bottom plug coupler is a block of elastic material, wherein the first bottom plug coupler is coupled to the first divider first end panel bottom side, wherein the first bottom plug coupler comprises a first bottom plug coupler center peak that extends through a first opening in the shopping cart basket bottom to couple the first divider to the shopping cart basket, and wherein the first bottom plug coupler center peak fills the first opening in response to the first bottom plug coupler center peak extending through the first opening;
a hollow first divider second end panel having a first divider second end front plate and a first divider second end rear plate spacedly coupled to the first divider second end front plate by a first divider second end panel top side, a first divider second end panel bottom side, a first divider second end panel outer side and a first divider second end panel inner side, wherein the first divider second end panel comprises:
a second bar clip coupled to the first divider second end panel outer side at the first divider second end, wherein the second bar clip couples to the top rail; and
a second bottom plug coupler, wherein the second bottom plug coupler is a block of elastic material, wherein the second bottom plug coupler is coupled to the first divider second end panel bottom side, wherein the second bottom plug
coupler comprises a second bottom plug coupler center peak that extends through a second opening in the shopping cart basket bottom to couple the first divider to the shopping cart basket, and wherein the second bottom plug coupler center peak fills the second opening in response to the second bottom plug coupler center peak extending through the second opening;
and
a first divider center panel slidingly coupled to both the first divider first end panel and the first divider second end panel, wherein the first divider center panel slides into and out of the first divider first end panel through a first divider first end panel opening through the first divider first end panel inner side, and wherein the first divider center panel slides into and out of the first divider second end panel through a first divider second end panel opening through the first divider second end panel inner side;
and
a second divider having a second divider first end and a second divider second end opposing the second divider first end, wherein the second divider comprises:
a hollow second divider first end panel having a second divider first end front plate and a second divider first end rear plate spacedly coupled to the second divider first end front plate by a second divider first end panel top side, a second divider first end panel bottom side, a second divider first end panel outer side and a second divider first end panel inner side, wherein the second divider first end panel comprises:
a third bar clip coupled to the second divider first end panel outer side at the second divider panel first end, wherein the third bar clip couples to the top rail; and
a third bottom plug coupler, wherein the third bottom plug coupler is a block of elastic material, wherein the third bottom plug coupler is coupled to the second divider first end panel bottom side, wherein the third bottom plug coupler
comprises a third bottom plug coupler center peak that extends through a third opening in the shopping cart basket bottom to couple the second divider to the shopping cart basket, and wherein the third bottom plug coupler center peak fills the third opening in response to the third bottom plug coupler center peak extending through the third opening;
a hollow second divider second end panel having a second divider second end front plate and a second divider second end rear plate spacedly coupled to the second divider second end front plate by a second divider second end panel top side, a second divider second end panel bottom side, a second divider second end panel outer side and a second divider second end panel inner side, wherein the second divider second end panel comprises:
a fourth bar clip coupled to the second divider second end panel outer side at the second divider panel second end, wherein the fourth bar clip couples to the top rail; and
a fourth bottom plug coupler, wherein the fourth bottom plug coupler is a block of elastic material, wherein the fourth bottom plug coupler is coupled to the second divider second end panel bottom side, wherein the fourth bottom plug
coupler comprises a fourth bottom plug coupler center peak that extends through a fourth opening in the shopping cart basket bottom to couple the second divider to the shopping cart basket, and wherein the fourth bottom plug coupler center peak fills the fourth opening in response to the fourth bottom plug coupler center peak extending through the fourth opening;
and
a second divider center panel slidingly coupled to both the second divider first end panel and the second divider second end panel, wherein the second divider center panel slides into and out of the second divider first end panel through a second divider first end panel opening through the second divider first end panel inner side, and wherein the second divider center panel slides into and out of the second divider second end panel through a second divider second end panel opening through the second divider second end panel inner side;
wherein the second divider center panel comprises a slot, and wherein the first divider center panel slides into the slot to couple the second divider to the first divider.

13. The combination of claim 12, wherein the first divider first end panel further comprises:
a first end front plate inner surface of the first divider first end front plate;
a first end rear plate inner surface of the first divider first end rear plate;
a front top ridge protruding from the first end front plate inner surface, wherein a front top ridge longitudinal axis is parallel to a first divider first end panel bottom side plane, wherein the front top ridge extends from the first divider first end panel inner side to the first divider first end panel outer side, and wherein the front top ridge is positioned closer to the first divider first end panel top side than the first divider first end panel bottom side;
a front bottom ridge protruding from the first end front plate inner surface, wherein a front bottom ridge longitudinal axis is parallel to the first divider first end panel bottom side plane, wherein the front bottom ridge extends from the first divider first end panel inner side to the first divider first end panel outer side, and wherein the front bottom ridge is positioned closer to the first divider first end panel bottom side than the first divider first end panel top side;
a rear top ridge protruding from the first end rear plate inner surface, wherein a rear top ridge longitudinal axis is parallel to the first divider first end panel bottom side plane, wherein the rear top ridge extends from the first divider first end panel inner side to the first divider first end panel outer side, and wherein the rear top ridge is positioned closer to the first divider first end panel top side than the first divider first end panel bottom side; and
a rear bottom ridge protruding from the first end rear plate inner surface, wherein a rear bottom ridge longitudinal axis is parallel to the first divider first end panel bottom side plane, wherein the rear bottom ridge extends from the first divider first end panel inner side to the first divider first end panel outer side, and wherein the rear bottom ridge is positioned closer to the first divider first end panel bottom side than the first divider first end panel top side.

14. The combination of claim 13, wherein a top ridge plane defined by the front top ridge and the rear top ridge is parallel to the bottom side plane.

15. The combination of claim 13, wherein a bottom ridge plane defined by the front bottom ridge and the rear bottom ridge is parallel to the bottom side plane.

16. The combination of claim 13, wherein the first divider center panel further comprises:
a rectangular first divider center panel frame surrounding a first divider center panel center section, wherein the first divider center panel frame comprises:
a first divider center panel top bar comprising:
a first divider center panel top bar longitudinal axis;
a first divider center panel top bar front surface;
a first divider center panel top bar front groove in the first divider center panel top bar front surface, wherein the first divider center panel top bar front groove has a top bar front groove longitudinal axis parallel to the first divider center panel top bar longitudinal axis, wherein the front top ridge slides into and out of the first divider center panel top bar front groove in response to the first divider center panel sliding into and out of the first divider first end panel;
a first divider center panel top bar rear surface; and
a first divider center panel top bar rear groove in the first divider center panel top bar rear surface, wherein the first divider center panel top bar rear groove has a top bar rear groove longitudinal axis parallel to the first divider center panel top bar longitudinal axis, wherein the rear top ridge slides into and out of the first divider center panel top bar rear groove in response to the first divider center panel sliding into and out of the first divider first end panel;
a first divider center panel bottom bar comprising:
a first divider center panel bottom bar front surface;
a first divider center panel bottom bar front groove in the first divider center panel bottom bar front surface, wherein the first divider center panel bottom bar front groove has a bottom bar front groove longitudinal axis parallel to the first divider center panel top bar longitudinal axis, wherein the front bottom ridge slides into and out of the first divider center panel bottom bar front groove in response to the first divider center panel sliding into and out of the first divider first end panel;
a first divider center panel bottom bar rear surface; and
a first divider center panel bottom bar rear groove in the first divider center panel bottom bar rear surface, wherein the first divider center panel bottom bar rear groove has a bottom bar rear groove longitudinal axis parallel to the first divider center panel top bar longitudinal axis, wherein the rear bottom ridge slides into and out of the first divider center panel bottom bar rear groove in response to the first divider center panel sliding into and out of the first divider first end panel;
a first divider center panel first side bar, wherein the first divider center panel first side bar slides into a first divider first end cavity in the first divider first end panel through the first divider first end panel opening to couple the first divider center panel to the first divider first end panel;
a first divider center panel second side bar, wherein the first divider center panel second side bar slides into a first divider second end cavity in the first divider send end panel through the first divider second end panel opening to couple the first divider center panel to the first divider second end panel;
and
a first mesh panel covering the first divider center panel center section.

17. The combination of claim 12, wherein first divider first end panel further comprises:
a first divider first end cavity between the first divider first end front plate and the first divider first end rear plate; and
a first divider first end panel opening into the first divider first end cavity through the first divider first end panel inner side, wherein the first divider center panel slides into and out of the first divider first end panel through the first divider first end panel opening.

18. The combination of claim 12, wherein the second divider center panel comprises an eight-sided second divider center panel frame surrounding a second divider center panel center section, wherein the second divider center panel frame comprises:
a second divider center panel top bar;
a second divider center panel first side bar coupled to and extending perpendicularly from the second divider center panel top bar;
a second divider center panel first bottom bar coupled to and extending perpendicularly from the second divider center panel first side bar;
a second divider center panel second side bar coupled to and extending perpendicularly from the second divider center panel top bar;
a second divider center panel second bottom bar coupled to and extending perpendicularly from the second divider center panel second side bar;
a slot first side bar coupled to and extending perpendicularly from the second divider center panel first bottom bar;
a slot second side bar coupled to and extending perpendicularly from the second divider center panel second bottom bar;
a slot top bar coupled to and extending perpendicularly from both the slot first side bar and the slot second side bar, wherein the slot top bar is parallel to the second divider center panel top bar;
and
a second mesh panel covering the second divider center panel center section.

19. The combination of claim 18, wherein the second divider slot top bar sets on the first divider center panel top bar in response to the second divider being coupled to the first divider.

20. The combination of claim 17, wherein the first divider second end panel is a mirror image of the first divider first end panel.
